(19) United States
(12) Patent Application Publication
(10) Pub. No.: US 2013/0222353 A1
(43) Pub. Date: Aug. 29, 2013

(54) PRISM ILLUMINATION-OPTIC

(71) Applicant: Timothy Andrew Large, Bellevue, WA (US)

(72) Inventor: Timothy Andrew Large, Bellevue, WA (US)

(73) Assignee: Microsoft Corporation, Redmond, WA (US)

(21) Appl. No.: 13/408,257

(22) Filed: Feb. 29, 2012

(51) Int. Cl. G09G 5/00; G09G 3/30; G09G 3/34

(52) U.S. Cl. 345/207; 345/76; 345/84

(57) ABSTRACT

This document describes techniques and apparatuses for implementing a prism illumination-optic for a vision-based interactive-display device. A vision-based interactive-display device includes a display to form images for viewing on a display surface of the device. The device further includes an illumination-optic having an upper face positioned towards the display surface and a lower face positioned towards the display. In accordance with various embodiments, the illumination-optic is configured with prisms on the lower face that reflect light out of the upper face of the illumination-optic to illuminate the display surface.

### BACKGROUND

Conventional display devices that are equipped with a camera behind or beneath a display surface can recognize physical objects that are placed on or near the display surface. In order to recognize physical objects, such display devices can illuminate the display surface to enable the camera to capture light reflected by the physical objects. It is difficult, however, to illuminate the display surface without the light used to illuminate the display surface propagating backwards and blinding the camera, making it difficult for conventional display devices to capture a clear image of physical objects on or near the display surface.

### SUMMARY

This document describes techniques and apparatuses for implementing a prism illumination-optic for a vision-based interactive-display device. A vision-based interactive-display device includes a display to form images for viewing on a display surface of the device. The device further includes an illumination-optic having an upper face positioned towards the display surface and a lower face positioned towards the display. In accordance with various embodiments, the illumination-optic is configured with prisms on the lower face that reflect light out of the upper face of the illumination-optic to illuminate the display surface. The illumination-optic solves many of the problems associated with conventional display devices by reflecting most of the light towards the display surface.

The device further includes an image detector configured to capture reflections of light from an object on or near the display surface when the display surface is illuminated. The device can then recognize the object based on the captured reflections of light, and control the display to form one or more images for viewing on the display surface that correspond to the recognized object.

This summary is provided to introduce simplified concepts in a simplified form that are further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and apparatuses for implementing a prism illumination-optic for a vision-based interactive-display device are described with reference to the following drawings. The same numbers are used throughout the drawings to reference like features and components:

FIG. 1 illustrates an example vision-based interactive-display device.

FIG. 2 illustrates a more detailed example of the optical system, including the illumination-optic, of the vision-based interactive-display device illustrated in FIG. 1.

FIG. 3 illustrates an example method for controlling a prism illumination-optic for a vision-based interactive-display device.

FIG. 4 illustrates an example device in which techniques for a prism illumination-optic for a vision-based interactive-display device can be implemented.

### DETAILED DESCRIPTION

Overview

This document describes techniques and apparatuses for implementing a prism illumination-optic for a vision-based interactive-display device. A vision-based interactive-display device is configured to respond to user gestures as well as physical, or real world, objects. Users can interact with the device by touching or dragging their fingertips and/or objects across a display surface of the device.

In various embodiments, a vision-based interactive-display device includes a display to form images for viewing on a display surface of the device. The device further includes an illumination-optic having an upper face positioned towards the display surface and a lower face positioned towards the display. In accordance with various embodiments, the illumination-optic is configured with prisms on the lower face. The illumination optic receives light from a light emitter, and the prisms act to reflect the light out of the upper face of the illumination optic to illuminate the display surface. The illumination-optic solves many of the problems associated with conventional display devices because the prisms cause the illumination-optic to reflect more light out of the upper face towards the display surface than out of the lower face towards the display. For example, the illumination-optic may project approximately six times more light towards the display surface than towards the display. Further, the illumination-optic projects light out of the upper face at a wide range of angles, while any light that escapes out of the lower face leaves the illumination-optic at angles close to glancing.

The device further includes an image detector configured to capture reflections of light from an object on or near the display surface when the display surface is illuminated. The device can then process the captured reflections of light to recognize the object on or near the display surface, and control the display to form one or more images for viewing on the display surface that correspond to the recognized object.

Example Environment

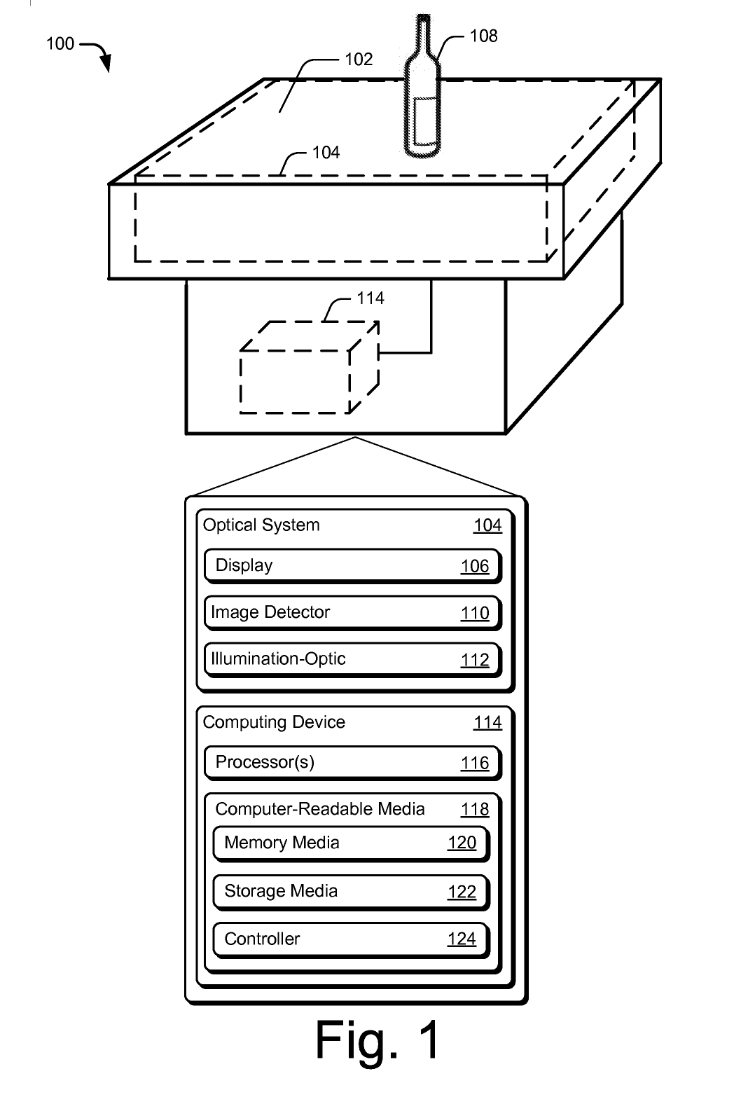

FIG. 1 is an illustration of an example vision-based interactive-display device 100. Device 100 includes a display surface 102, which in this example is oriented horizontally. Alternately, however, display surface 102 may be oriented vertically, such as a screen of a typical television device. An optical system 104 is located beneath, or behind, display surface 102 and is configured to provide display functionality and vision-based input functionality for device 100.

To provide display functionality, optical system 104 is configured to form an image for viewing on display surface 102 using a display 106. Display 106 can be a liquid crystal display (LCD), a partially-transparent organic light-emitting diode (OLED) display, or any other type of partially-transparent display that is configured to form two-dimensional, three-dimensional, and/or multi-view images.

To provide vision-based input functionality, optical system 104 is configured to capture reflections of light from object(s) 108 on or near display surface 102 using an image detector 110, such as a digital camera. In this example, object 108 is depicted as a wine bottle. As described herein, however, objects 108 can include both physical objects (such as game pieces, electronic devices, or beverages), as well as user gestures (e.g., user gestures above the display surface and/or user gestures made by physically touching the display surface with fingers or a physical object). Such user gestures are well known and are not discussed in detail herein. In order to capture reflections of light from objects 108, optical system 104 illuminates display surface 102 using an illumination-optic 112, which is discussed in more detail below.

Vision-based interactive-display device 100 also includes a computing device 114 coupled to optical system 104. In this example, computing device 114 is located inside device 100. Alternately, computing device 114 can be located remote from device 100 and coupled to optical system 104 via a wired or wireless communication link. Computing device 114 includes processor(s) 116 and computer-readable media 118, which includes memory media 120 and storage media 122. Computer-readable media 118 also includes a controller 124. Controller 124 is configured process captured reflections of light from objects 108 on or near display surface 102 to recognize the objects. Controller 124 can then control display 106 to form one or more images for viewing on display surface 102 that correspond to the recognized objects. How controller 124 is implemented and used varies, and is described as part of the method discussed below.

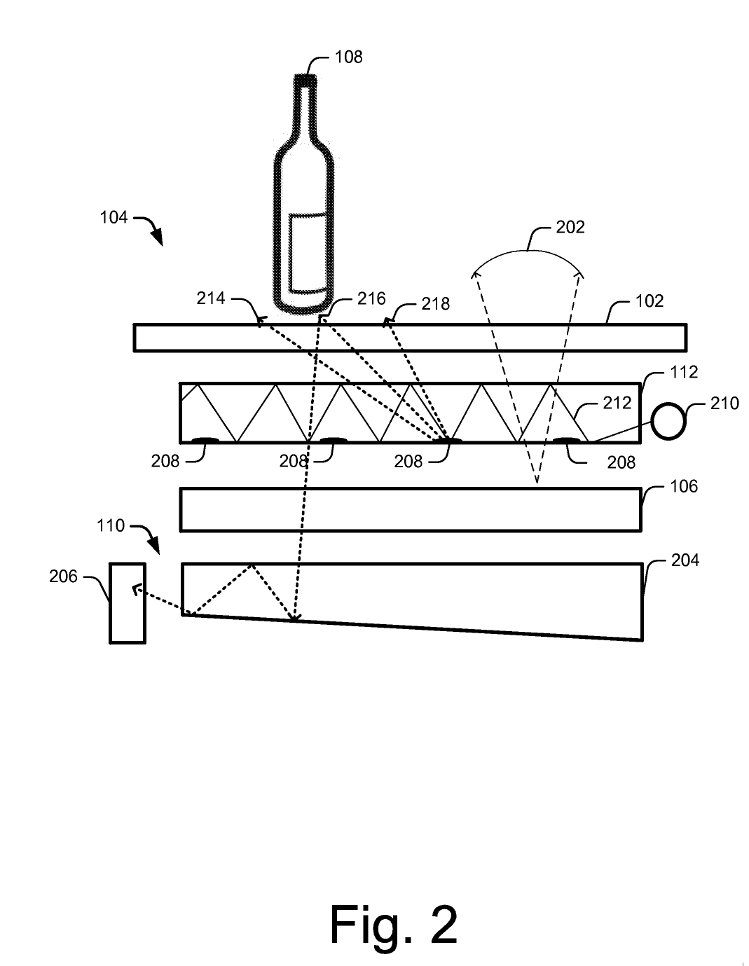

FIG. 2 illustrates a more detailed example of optical system 104. In this example, illumination-optic 112 overlays, or is in front of, display 106, and image detector 110 is positioned below, or behind, display 106. It is to be appreciated, however, that optical system 104 may be arranged in other configurations as well. For example, in one embodiment illumination-optic 112 can be positioned underneath, or behind, display 106.

Display 106 is configured to form an image 202 for viewing on display surface 102. Display 106 can be an LCD, a partially transparent OLED, or other partially transparent display. In an embodiment, display 106 is partially transparent so that image detector 110 is able to capture reflections of light from objects 108 placed on or near display surface 102. In some embodiments, display 106 is implemented as an LCD and includes an LCD backlight and an LCD control layer. The LCD backlight is configured to project light through the LCD control layer to form image 202 for viewing on display surface 102. The LCD backlight may comprise any type of light source configured for use in an LCD display system, such as one or more light-emitting diodes (LEDs) or one or more compact cylindrical fluorescent light sources (CCFL). The LCD control layer is a display-image-forming layer configured to transmit image 202 for viewing on display surface 102. The LCD control layer may include a two-dimensional diffraction-optic configured to spatially and temporally modulate light from the LCD backlight to form image 202.

Illumination-optic 112 is configured to illuminate display surface 102. In some embodiments, illumination-optic comprises a lightguide, such as a wedge-shaped lightguide or a sheet-like lightguide. Image detector 110 is configured to capture reflections of light from one or more objects 108 (such as game pieces, fingers, electronic devices, or beverages) on or near display surface 102 when display surface 102 is illuminated. In some embodiments, image detector 110 can be implemented as a digital camera. In this example, image detector 110 is implemented as a wedge-optic 204 and a digital camera 206.

Illumination-optic 112 includes an upper face positioned towards display surface 102 and a lower face positioned towards display 106. The lower face of illumination-optic 112 is configured with prisms 208. Prisms 208 are transparent, optical elements with flat polished surfaces that are used to reflect light. In this example, prisms 208 protrude from the lower face towards the upper face of illumination-optic 112. Alternately, prisms 208 can be indented into the lower face of illumination-optic 112 towards display 106. Prisms 208 can be random or regular prisms with a large included angle. For example, in one embodiment, the included angle of prisms 208 is approximately 120 degrees. This large included angle enables prisms 208 to reflect light at a wide angle of angles.

In some embodiments, prisms 208 are small and sparsely populated on the lower face of illumination-optic 112. As described herein, “small and sparsely populates” refers to a size of each prism being significantly less than a distance between each prism. For example, each prism may be approximately 4 micrometers high, and there may be approximately 500 micrometers between each prism. Prisms 208 can be constructed of transparent plastic or glass, and are positioned on the underside of illumination-optic 112.

In at least one embodiment, illumination-optic 112 is bonded to a chemically-strengthened glass front plate that has a refractive index of approximately 1.54. Glass that is chemically-strengthened is typically dark to infrared. In this embodiment, therefore, the lightguide of illumination-optic 112 may be made from polycarbonate, with a refractive index of approximately 1.585, and bonded to the chemically-strengthened glass front plate with a silicone adhesive that has a refractive index of approximately 1.41. This ensures that light from one or more light emitters 210, positioned along the side of illumination-optic 112, is able to make it to the center of display 106 without excessive loss. The chemically-strengthened glass front plate illuminates objects 108 on or near display surface 102 while simultaneously providing protection for display 106.

In this example, light emitter 210 is controlled to emit light 212 into illumination-optic 112. FIG. 2 illustrates a single light emitter 210, however, it is to be noted that multiple light emitters 210 can be arranged along one or more sides of illumination-optic 112, and can be implemented as an array of LEDs, such as infrared or visible LEDs. As illustrated in FIG. 2, light 212 emitted into illumination-optic 112 reflects, via total-internal-reflection (TIR), from the upper face to the lower face of illumination-optic 112.

When emitted light 212 strikes one of prisms 208, the prism reflects light rays 214, 216, and 218, out of the upper face of illumination-optic 112 at a wide range of angles to illuminate display surface 102. As each prism 208 can reflect light at a wide range of angles, display surface 102 is uniformly illuminated by illumination-optic 112. Further, because there are no prisms on the upper face of illumination-optic 112, any light that escapes from the lower face leaves illumination-optic 112 at an angle that is close to glancing, or shallow. It is to be noted that prisms 208 cause illumination-optic 112 to project more light out of the upper face towards display surface 102 than out of the lower face towards display 106. For example, the amount of light projected from the upper face may be approximately six times the amount of light that escapes from the lower face.

In this example, light ray 216 hits object 108 and reflects back into the device towards wedge-optic 204. Wedge-optic 204 receives reflected light ray 216 and provides reflected light ray 216 to digital camera 206. Digital camera 206 receives and captures reflected light ray 216, and provides the captured reflection of light to controller 124. Controller 124 receives and processes the captured reflection of light to recognize object 108. Controller 124 can then control display 106 to form one or more images for viewing on display surface 102 that correspond to recognized object 108. In this example, controller 124 can process the captured reflection of light to recognize object 108 as a wine bottle corresponding to a specific type of wine, and then control display 106 to form one or more images for viewing on display surface 102 which correspond to the specific type of wine. Such images might include a description of the wine, a price of the wine, or information about where the wine is made.

Example Method

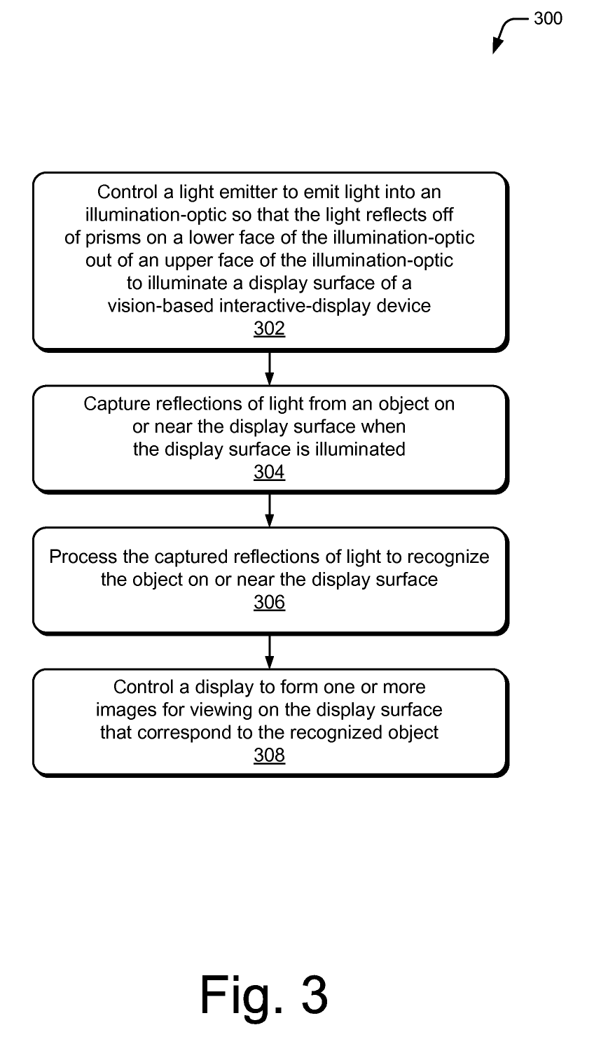

FIG. 3 is flow diagram depicting an example method 300 for controlling a vision-based interactive-display device.

Block 302 controls a light emitter to emit light into an illumination-optic so that the light reflects off of prisms on a lower face of the illumination-optic out of an upper face of the illumination-optic to illuminate a display surface of a vision-based interactive-display device. For example, controller 124 controls light emitters 210 to emit light into illumination-optic 112 so that the light reflects off of prisms on the lower face of illumination-optic 112 and out of the upper face of illumination-optic 112 to illuminate display surface 102 of vision-based interactive-display device 100.

Block 304 captures reflections of light from an object on or near the display surface when the display surface is illuminated. For example, image detector 110 captures reflections of light from object 108 placed on or near display surface 102 when display surface 102 is illuminated.

Block 306 processes the captured reflections of light to recognize the object on or near the display surface. For example, controller 124 processes the captured reflections of light received from image detector 110 to recognize object 108 on or near display surface 102.

Block 308 controls a display to form one or more images for viewing on the display surface that correspond to the recognized object. For example, controller 124 controls display 106 to form one or more images 202 for viewing on display surface 102 that correspond to recognized object 108.

Example Device

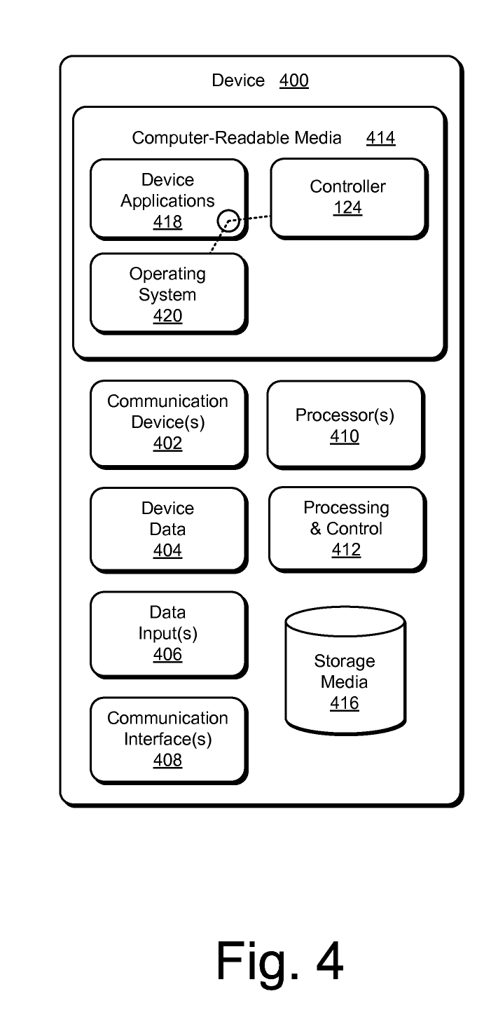

FIG. 4 illustrates various components of example device 400 that can be implemented as any type of client, server, and/or vision-based interactive-display device as described with reference to the previous FIGS. 1-3 to implement techniques enabling an illumination-optic for a vision-based interactive-display device. In embodiments, device 400 can be implemented as one or a combination of a wired and/or wireless device, as a form of flat panel display, television, television client device (e.g., television set-top box, digital video recorder (DVR), etc.), consumer device, computer device, server device, portable computer device, user device, communication device, video processing and/or rendering device, appliance device, gaming device, electronic device, and/or as another type of vision-based interactive-display device. Device 400 may also be associated with a viewer (e.g., a person or user) and/or an entity that operates the device such that a device describes logical devices that include users, software, firmware, and/or a combination of devices.

Device 400 includes communication devices 402 that enable wired and/or wireless communication of device data 404 (e.g., received data, data that is being received, data scheduled for broadcast, data packets of the data, etc.). The device data 404 or other device content can include configuration settings of the device, media content stored on the device, and/or information associated with a user of the device. Media content stored on device 400 can include any type of audio, video, and/or image data. Device 400 includes one or more data inputs 406 via which any type of data, media content, and/or inputs can be received, such as user-selectable inputs, messages, music, television media content, recorded video content, and any other type of audio, video, and/or image data received from any content and/or data source.

Device 400 also includes communication interfaces 408, which can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices communicate data with device 400.

Device 400 includes one or more processors 410 (e.g., any of microprocessors, controllers, and the like), which process various computer-executable instructions to control the operation of device 400 and to enable techniques for implementing an illumination-optic for a vision-based interactive-display device. Alternatively or in addition, device 400 can be implemented with any one or combination of hardware, firmware, or fixed logic circuitry that is implemented in connection with processing and control circuits which are generally identified at 412. Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 400 also includes computer-readable storage media 414, such as one or more memory devices that enable persistent and/or non-transitory data storage (i.e., in contrast to mere signal transmission), examples of which include random access memory (RAM), non-volatile memory (e.g., any one or more of a read-only memory (ROM), non-volatile RAM (NVRAM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 400 can also include a mass storage media device 416.

Computer-readable storage media 414 provides data storage mechanisms to store the device data 404, as well as various device applications 418 and any other types of information and/or data related to operational aspects of device 400. For example, an operating system 420 can be maintained as a computer application with the computer-readable storage media 414 and executed on processors 410. The device applications 418 may include a device manager, such as any form of a control application, software application, signal-processing and control module, code that is native to a particular device, a hardware abstraction layer for a particular device, and so on.

The device applications 418 also include any system components or modules to implement techniques using or enabling an illumination-optic for a vision-based interactive-display device. In this example, the device applications 418 can include controller 124, which is configured to provide display data to and receive input data from optical system 104.

### CONCLUSION

This document describes various apparatuses and techniques for implementing an illumination-optic for a vision-based interactive-display device. Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A vision-based interactive-display device comprising:
a display configured to form images for viewing on a display surface of the vision-based interactive-display device;
an illumination-optic having an upper face positioned towards the display surface and a lower face positioned towards the display, the illumination-optic configured with prisms on the lower face that reflect light out of the upper face of the illumination optic to illuminate the display surface; and
an image detector configured to capture reflections of light from an object on or near the display surface when the display surface is illuminated.

2. A vision-based interactive-display device as described in claim 1, wherein the prisms cause the illumination-optic to project more light out of the upper face towards the display surface than out of the lower face towards the display.

3. A vision-based interactive-display device as described in claim 1, wherein the illumination-optic comprises a lightguide.

4. A vision-based interactive-display device as described in claim 1, further comprising one or more light emitters configured to emit the light into the illumination-optic, the illumination optic further configured to receive the light from the one or more light emitters and to reflect the light out of the upper face of the illumination-optic to illuminate the display surface.

5. A vision-based interactive-display device as described in claim 4, wherein the one or more light emitters comprise one or more light-emitting diodes (LEDs) positioned along edges of the illumination-optic.

6. A vision-based interactive-display device as described in claim 5, wherein the one or more LEDs are infrared or visible LEDs.

7. A vision-based interactive-display device as described in claim 1, wherein a size of each of the prisms is significantly less than a distance between each of the prisms on the lower face of the illumination-optic.

8. A vision-based interactive-display device as described in claim 1, wherein the prisms reflect the light at a wide range of angles out of the upper face of the illumination-optic.

9. A vision-based interactive-display device as described in claim 1, wherein the prisms have an included angle of approximately 120 degrees.

10. A vision-based interactive-display device as described in claim 1, wherein the prisms protrude from the lower face of the illumination-optic towards the upper face of the illumination-optic or are indented into the lower face of the illumination-optic towards the display.

11. A vision-based interactive-display device as described in claim 1, wherein the illumination-optic is bonded to a chemically-strengthened glass front plate that protects the display.

12. A vision-based interactive-display device as described in claim 1, wherein the display comprises a liquid crystal display (LCD) or an organic light-emitting diode (OLED) display.

13. A vision-based interactive-display device as described in claim 1, wherein the image detector comprises a digital camera.

14. A vision-based interactive-display device as described in claim 1, wherein the image detector comprises at least a wedge-optic and a digital camera, the wedge-optic configured to receive the reflections of light, and provide the reflections of light to the digital camera to enable the digital camera to capture the reflections of light.

15. A vision-based interactive-display device as described in claim 1, further comprising at least a memory and a processor to implement a controller, the controller configured to process the reflections of light to recognize the object.

16. A vision-based interactive-display device as described in claim 15, wherein the controller is further configured to control the display to form one or more images for viewing on the display surface that correspond to the recognized object.

17. A method comprising:
controlling a light emitter to emit light into an illumination-optic so that the light reflects off of prisms on a lower face of the illumination-optic out of an upper face of the illumination-optic to illuminate a display surface of a vision-based interactive-display device;
capturing reflections of light from an object on or near the display surface when the display surface is illuminated;
processing the captured reflections of light to recognize the object on or near the display surface; and
controlling a display to form one or more images for viewing on the display surface that correspond to the recognized object.

18. A method as described in claim 17, wherein the illumination-optic comprises a lightguide.

19. A method as described in claim 17, wherein a size of each of the prisms is significantly less than a distance between each of the prisms on the lower face of the lightguide.

20. A vision-based interactive-display device comprising:
a liquid crystal display configured to form images for viewing on a display surface of the vision-based interactive-display device;
a lightguide comprising a lower face and an upper face, the lower face having small prisms that are sparsely populated across the lower face of the lightguide, each of the prisms having an included angle of approximately 120 degrees, and the lightguide configured to receive infrared light from one or more light-emitting diodes (LEDs) and to reflect the infrared light off of the prisms and out of the upper face of the lightguide at a wide range of angles to uniformly illuminate the display surface;
a digital camera configured to capture reflections of light from an object on or near the display surface when the display surface is illuminated; and
a computing device comprising at least a memory and a processor to implement a controller, the controller configured to receive the captured reflections of light, process the captured reflections of light to recognize the object, and control the liquid crystal display to form one or more images for viewing on the display surface that corresponds to the recognized object.
